(19) United States
(12) Patent Application Publication
(10) Pub. No.: US 2005/0047031 A1
(43) Pub. Date: Mar. 3, 2005

(54) Lighting control apparatus for vehicles

(75) Inventor: Hiromichi Naito, Okazaki-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/911,589

(22) Filed: Aug. 5, 2004

(30) Foreign Application Priority Data
Aug. 26, 2003 (JP) 2003-301418

(51) Int. Cl. H02H 7/00

(52) U.S. Cl. 361/18

(57) ABSTRACT

A vehicle includes a plurality of switch devices including respective LEDs, which are turned on to illuminate when a lighting switch for headlights and taillights is activated. A current flowing in one of the switch devices is detected and a current supplied from a battery to the switch devices is controlled by a regulator circuit and a single transistor based on the detected current. A voltage corresponding to a battery voltage is superimposed on a current detection voltage, and the regulator circuit immediately stops the current when the battery voltage excessively increases.

### CROSS REFERENCE TO RELATED APPLICATION

This application is based on and incorporates herein by reference Japanese Patent Application No. 2003-301418 filed on Aug. 26, 2003.

### FIELD OF THE INVENTION

The present invention relates to a lighting control apparatus for vehicles, which controls lights of substantially the same luminance provided in a plurality of switch devices installed in a vehicle.

### BACKGROUND OF THE INVENTION

In a vehicle, a plurality of switch devices is installed on an instrument panel to be manually operated by a vehicle driver. As shown in FIG. 3, each switch device 2 has a light source, which is constructed with a plurality of light emitting diodes (LEDs) 1 connected in series and in parallel as shown in FIG. 3. The light source is connected in series with a storage battery 4, a transistor 51, a transistor 5 and an emitter resistor 6. The base of the transistor 5 is connected to a junction of a resistor 7 and a Zener diode 8 through a base resistor 9.

When a lighting switch 3 is activated to turn on vehicle lights (headlights and taillights) 60 at night, for instance, a microcomputer 50 responsively turns on the transistor 51 so that electric power is supplied from the storage battery 4 to the LEDs 1 through the transistor 51, the transistor 5 and the resistor 6. The base potential of the transistor 5 is regulated at a fixed voltage by the Zener diode 8, even when the voltage of the battery 4 fluctuates. Thus, the current to the LEDs 1 is substantially unchanged to maintain substantially the same luminance of the LEDs 1 among the switch devices 2. In this apparatus, the number of electronic switching circuits such as transistors 5 will increase as the number of switch devices 2 increases.

### SUMMARY OF THE INVENTION

It is therefore an object of the present invention to provide a light control apparatus for vehicles, which does not require electronic switching circuits for each switch device.

According to the present invention, a lighting control apparatus for vehicles is connected to a battery and a plurality of switch devices including light components, respectively. The apparatus has a current supply switch, a current detection circuit and a regulator circuit. The current supply switch is connected to all the switch devices to supply a current from the battery to the light components. The current detection circuit is connected to only one of the switch devices for detecting the current flowing in the only one of the switch devices. The regulator circuit regulates the current in accordance with the current detected by the current detecting means. Thus, the construction of the apparatus is simplified by the use of the single current supply switch and the single current detecting circuit, even when the number of the switch devices is increased.

Further, a voltage indicative of the battery voltage is superimposed on a current detection voltage and the regulator circuit controls the current supply switch based on the sum of the voltages. Thus, the regulator circuit not only feedback controls the current supplied to the switch devices, but also stops the current supply immediately when the battery voltage rises excessively.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing a light control apparatus for vehicles according to an embodiment of the present invention;

FIG. 2 is a time chart showing operation of the embodiment; and

FIG. 3 is a circuit diagram showing a light control apparatus for vehicles according to a related art.

### DETAILED DESCRIPTION OF THE PREFERRED EMBODIMENT

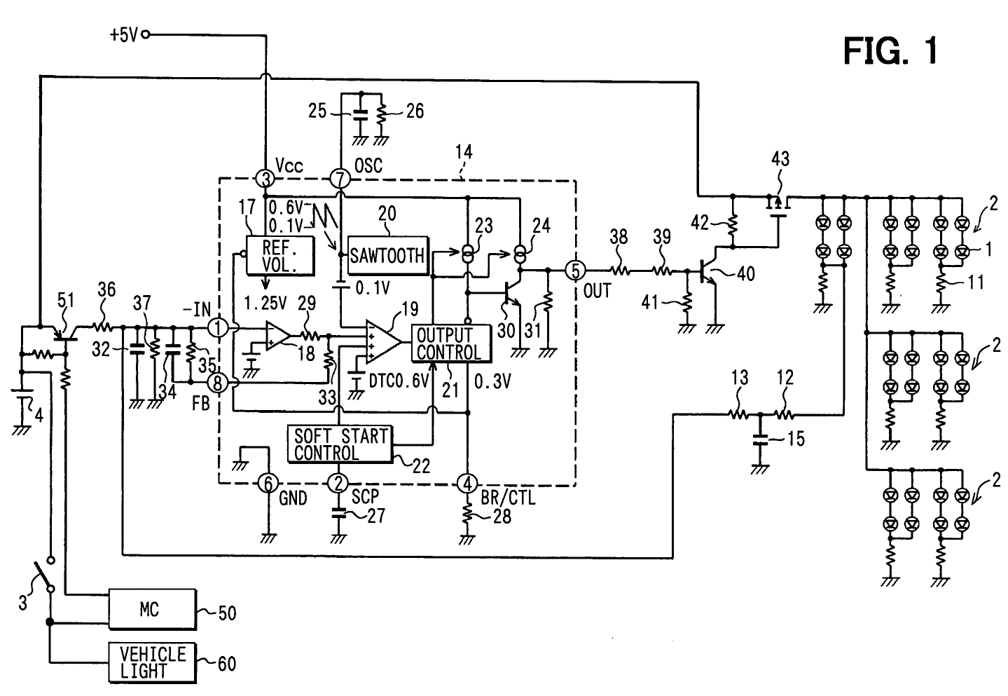

Referring first to FIG. 1, a plurality of switch devices 2 are connected in parallel with each other and connected in series with a battery 4. Resistors 11 are connected in series between the switch devices 2 and the ground, respectively, and a switching transistor 43 is connected in common between the battery and the switch devices 2. One of the switch devices 2 is connected to an input terminal (−IN) of a regulator circuit 14 through a series of resistors 12 and 13. The resistors 12 and 13 are for detecting a current flowing in the switch device 2. A capacitor 15 is connected to the resistors 12 and 13.

The regulator circuit 14 is a pulse width modulation (PWM) integrated circuit, for instance MB3800 manufactured by FUJITSU SEMICONDUCTOR DEVICES, to produce a PWM output signal from its output terminal (OUT). The regulator circuit 14 includes a reference voltage source 17, an error amplifier 18, a PWM comparator 19, a sawtooth signal generator 20, an output drive control circuit 21, a soft start control circuit 22, and the like.

The regulator circuit 14 is connected to a voltage source (5 V) of an operating voltage of 5 volts through its terminal (Vcc) to supply it to the reference voltage source 17 and current sources 23, 24. The regulator circuit 14 is connected to the ground through a terminal (OSC) and a parallel circuit of a capacitor 25 and a resistor 26, which determines the frequency of a sawtooth signal generated by the sawtooth signal generator 20. The regulator circuit 14 is grounded through a terminal (SCP) and a capacitor 27, which determines the operation characteristic of the soft start circuit 22. The regulator circuit 14 is connected to the ground through a terminal (BR/CTL) and a resistor 28, which maintains the regulator circuit 14 to be continuously active.

The reference voltage source 17 generates a reference voltage of about 1.25 volts, which is temperature-compensated, from the operating voltage of 5 volts. The error amplifier 18 is connected to the input terminal (−IN) at its inverting terminal (−) and a reference voltage of 0.5 volts at its non-inverting terminal (+). The error amplifier 18 is connected to one of input terminals of the PWM comparator 19 through its output terminal and a resistor 29.

The PWM comparator 19 has one inverting terminal (−) and three non-inverting terminals (+). The sawtooth signal of the sawtooth signal generator 20 is applied to the inverting terminal (−) through an offset voltage of 0.1 volt. The sawtooth signal changes its amplitude between 0.1 volt and 0.6 volts, and hence the input voltage applied to the inverting terminal changes between 0.2 volts and 0.7 volt. The PWM comparator 19 receives at its non-inverting terminals an output signal of the soft start control circuit 22, a stop period setting voltage of 0.6 volts. Thus, the PWM comparator 19 outputs a high level (H) signal when the sawtooth signal voltage is lower than the output voltage of the error amplifier 18, the soft start setting voltage and the stop period setting voltage.

The output drive control circuit 21 is constructed in a Totem-pole form to directly drive a transistor 30. The collector of the transistor 30 is connected the current source 24. It is also connected to the output terminal (OUT) and to the ground through a resistor 31 of 30 kilo ohms. The emitter of the transistor 30 is grounded. The input terminal (−IN) of the regulator circuit 14 is grounded through a capacitor 32. The output terminal (FB) of the error amplifier 18 is connected through a resistor 33 to a junction between a resistor 29 and one non-inverting input terminal (+) of the PWM comparator 19. A parallel circuit of a capacitor 34 and a resistor 35 is connected between the input terminal (−IN) and the output terminal (FB). The input terminal (−IN) is also connected to a junction between resistors 36 and 37, which divide the voltage of the battery 4 supplied through a transistor 51. The resistances of the resistors 36 and 37 are determined to apply a voltage of 0.5 volts under normal condition of the battery 4.

The output terminal (OUT) of the regulator circuit 14 is connected to the base of a transistor 40 through a series circuit of resistors 38 and 39. The base of the transistor 40 is grounded through a resistor 41. The collector of the transistor 40 is connected to the battery 4 through a resistor 42 and to the gate of a P-channel field effect transistor (FET) 43 provided as a switching component. The emitter of the transistor 40 is grounded.

The source of the FET 43 is connected to the battery 4, and the anode of the same is connected in common to the anodes of the LEDs 1 of all the switch devices 2. Thus, when the lighting switch 3 is kept activated to turn on the vehicle head and taillights 60, the regulator circuit 14 PWM-controls the FET 43 so that luminance of the LEDs 1 may be maintained.

More specifically, when the lighting switch 3 is activated and the transistor 51 is turned on by the microcomputer 50, the resistors 36 and 37 apply the divided voltage to the input terminal (−IN) of the regulator circuit 14. The soft start control circuit 22 operates to gradually increase the ON period of the PWM signal generated by the PWM comparator 19 and applied to the transistor 40 and FET 43. During the ON period of the PWM signal, the transistor 40 turns on and the FET 43 supplies the battery current to the LEDs 1.

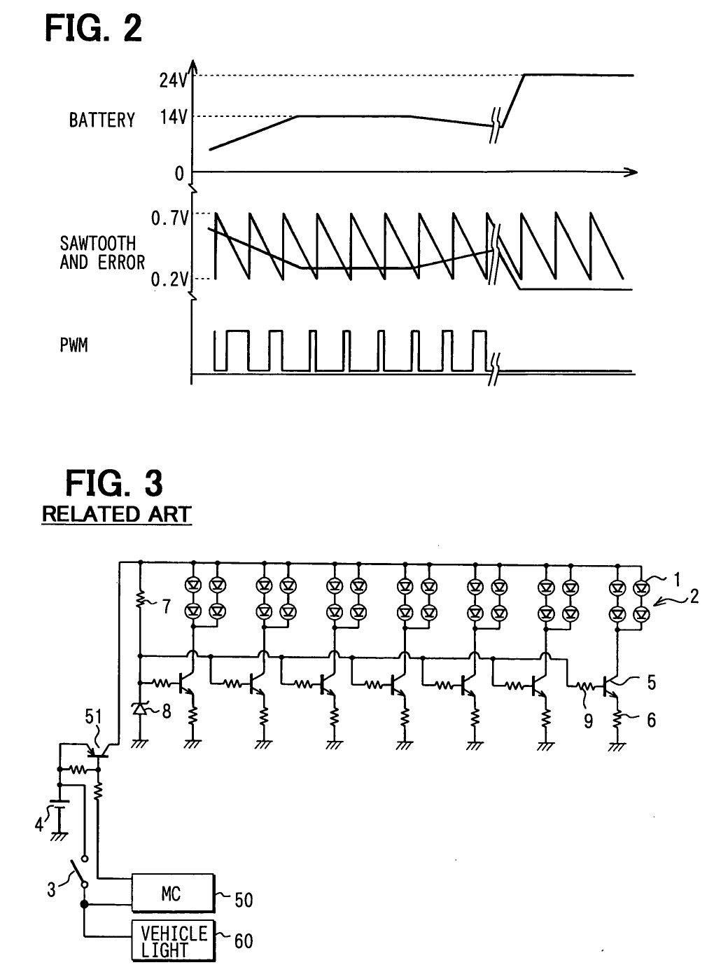

The voltage of the battery 4 normally changes as shown in FIG. 2 (left and central sides), usually under a maximum of 14 volts, depending on electric load conditions. As this voltage increases, the current detection voltage indicative of the current supplied to the LEDs 1 and detected by the resistors 12 and 13 proportionally increases. This current detection voltage is applied to the error amplifier 18 through the input terminal (−IN). The error output voltage of the error amplifier 18 gradually decreases as shown in FIG. 2 with the increase in the current detection voltage. The PWM comparator 19 compares this error voltage and the sawtooth signal voltage and produces the PWM signal voltage. The ON period (high level period) thus gradually decreases as shown in FIG. 2 as the error voltage decreases. As a result, the FET 43 shortens its ON period to reduce the current supplied to the LEDs 1. Thus, the current supplied to the LEDs is feedback-controlled to maintain the luminance of the light source among the switch devices 2.

A vehicle engine sometimes cannot be successfully started by a starter motor in extremely cold areas. In this instance, an additional battery may be connected in series with the battery 4 thereby to drive the starter motor with higher voltages. If such an additional battery is used, the input voltage applied to the input terminal (−IN) of the regulator circuit 14 responsively and excessively increases as shown in FIG. 2 (right side). Therefore, the error voltage produced form the error amplifier 18 immediately decreases and to be below 0.2 volts (minimum voltage of the sawtooth signal voltage), the PWM output signal voltage produced from the PWM comparator 19 remains low (no ON period). Thus, the LEDs 1 are protected from the excessive voltage, before the excessive current supplied to the LEDs 1 is detected and feedback-controlled to reduce the current.

In the above embodiment, all the switch devices 2 (LEDs 1) are controlled by one FET 43 and the current supplied to the switch devices 2 is detected by one current detecting circuit (resistors 12 and 13) for the feedback control. Therefore, even if the number of switch devices 2 increases, electronic circuits associated with the switch devices 2 need not be increased in proportion. Further, the total battery voltage is detected by the resistors 36, 37 and superimposed with the current detection voltage produced by the resistors 12, 13, the LEDs 1 can be quickly protected from excessive currents.

The present invention should not be limited to the above embodiment, but may be implemented in many other ways. For instance, the FET 43 may be replaced with a bipolar transistor or an IGBT. The LEDs 1 may be replaced with other light emitting components.

1. A lighting control apparatus for vehicles having a battery and a plurality of switch devices including light components, respectively, the apparatus comprising:
switching means connected to all the switch devices to supply a current from the battery to the light components of the switch devices; and
current detecting means connected to only one of the switch devices for detecting the current flowing in the light component in the only one of the switch devices;
regulator means for regulating a supply of the current in accordance with the current detected by the current detecting means.

2. The lighting control apparatus as in claim 1, wherein:
the regulator means includes a pulse width modulation circuit which controls the switching means by a pulse signal; and
the pulse width modulation circuit modulates a pulse width of the pulse signal in accordance with an input voltage thereto, the input voltage being a superimposition of a first voltage corresponding to the current detected by the current detecting means and a second voltage corresponding to a voltage of the battery.

3. The lighting control apparatus as in claim 1, further comprising:
battery voltage detecting means for detecting a voltage of the battery,
wherein the regulator means stops the supply of the current to the light components when the voltage of the battery exceeds a predetermined level.

4. The lighting control apparatus as in claim 3, wherein:
the current detecting means produces a current voltage indicative of the current flowing in the light component; and
the regulator means reduces the current to the light components as a sum of the battery voltage and the current voltage increases.

5. The lighting control apparatus as in claim 1, wherein the switching means includes a single transistor controlled by the regulator means.

6. The lighting control apparatus as in claim 1, wherein the regulator means and the switching means are rendered operative in response to a lighting switch which activates a vehicle light.

7. The lighting control apparatus as in claim 1, wherein all the switch devices are connected in series with the switching means and in parallel with each other.

8. The lighting control apparatus as in claim 1, wherein each of the switch devices include a plurality of light emitting diodes connected in series and in parallel to each other.
